(19) United States
(12) Patent Application Publication
(10) Pub. No.: US 2026/0167438 A1
(43) Pub. Date: Jun. 18, 2026

(54) FLOW CONTROL BRAKING SYSTEMS AND METHODS

(71) Applicant: Innovation Associates, Inc., Johnson City, NY (US)

(72) Inventors: Benjamin Barnum, Johnson City, NY (US); Tristin Brown, Johnson City, NY (US)

(21) Appl. No.: 19/420,118

(22) Filed: Dec. 15, 2025

Related U.S. Application Data
(60) Provisional application No. 63/733,562, filed on Dec. 13, 2024.

(51) Int. Cl. B65G 51/16; B65G 51/20

(52) U.S. Cl. CPC B65G 51/16; B65G 51/20; B65G 2203/0233; B65G 2203/025

(57) ABSTRACT

An apparatus, system, and method of a flow control braking system for controlling the flow of medication containers in a pneumatic pathway of a pneumatic conveyance system are disclosed herein. A butterfly valve is disposed downstream of a blower in the pneumatic pathway and is configured to reduce or increase the velocity of a medication container before reaching a destination in the pneumatic pathway. A plurality of sensors allows for the determination of the velocity of the medication container in the pneumatic pathway and for verification that the medication container has reached certain points in the pneumatic pathway. The flow control braking system reduces the instance of breakages of medication containers in transit and eliminates the need for multiple instances of compressed air on a single pneumatic pathway.

### RELATED APPLICATIONS

This application claims the benefit of and priority to U.S. Provisional Patent Application No. 63/733,562 filed Dec. 13, 2024, entitled “FLOW CONTROL BRAKING SYSTEMS AND METHODS”, the entirety of which is incorporated herein by reference.

### BACKGROUND

Pneumatic conveyance systems are convenient and efficient systems for the transportation of cylindrical apparatus, such as medication vials. These conveyance systems use forced air through cylindrical tubing to deliver medication vials from one point to another. These conveyance systems, while convenient for the transportation of medication vials, suffers from a lack of velocity control, especially near the destination. For example, conventional conveyance systems used compressed air at multiple points along a single conveyance line in order to ensure that the medication vial travels all the way to the destination at a reasonable average velocity, but with large variations in velocity over the length of the conveyance line. Traditional compressed air systems suffer from a tendency to have the medication vials arrive at the destination with too much velocity. This causes the medication vials, many of which are made of fragile materials, to break at excessive rates.

Further, as these conveyance lines and systems become longer and more complex, the amount of compressed air systems needed to transport a single medication vial from start to destination becomes unreasonably expensive, and the space required to house these systems becomes excessive.

A need accordingly exists for a process that reduces or eliminates the instance of breakages in medication vials in pneumatic conveyance systems. The pneumatic conveyance system should be capable of consistent velocity control of the medication vial in the line. Finally, the pneumatic conveyance system should eliminate the need for multiple compressed air lines.

Additionally, a need exists for a method to consistently control the velocity of the medication vials in the line and prevent breakages of the medication vials.

### SUMMARY

Example systems, methods, and apparatus are disclosed herein for controlling flow and medication container velocity in a pneumatic medication vial conveyance system. Specifically, systems, methods, and apparatus for blower-fed pneumatic conveyance system comprising flow-control valves are disclosed.

In light of the disclosure herein and without limiting the disclosure in any way, in an aspect of the present disclosure, which may be combined with any other aspect listed herein unless specified otherwise, a flow control braking system is provided, where the system comprises a programmable logic controller, a blower, at least one pneumatic pathway in pneumatic communication with the blower, at least one butterfly valve in pneumatic communication with the blower and the at least one pneumatic pathway, and a plurality of sensors disposed along the pneumatic pathway. The plurality of sensors and the at least one butterfly valve are in operative communication with the programmable logic controller. Further, a first sensor of the plurality of sensors is configured to determine when a medication container is present at a first position in the at least one pneumatic pathway, a second sensor of the plurality of sensors is disposed downstream of the first sensor and is configured to determine when the medication container is present at a second position in the at least one pneumatic pathway, and the programmable logic controller is configured to at least partially close the at least one butterfly valve at a determined time based at least in part on data from the determinations of the first sensor and the second sensor.

In another aspect of the present disclosure, which may be combined with any other aspect in combination with any other aspect listed herein unless specified otherwise, the data from the determinations from the first sensor and the second sensor are used by the programmable logic controller to determine a speed of the medication container.

In another aspect of the present disclosure, which may be combined with any other aspect in combination with any other aspect listed herein unless specified otherwise, the system further comprises a third sensor disposed downstream of the second sensor and configured to determine when the medication container is present at a third position in the at least one pneumatic pathway.

In another aspect of the present disclosure, which may be combined with any other aspect in combination with any other aspect listed herein unless specified otherwise, the third position is disposed near an end of the at least one pneumatic pathway and data from the determination of the third sensor is used by the programmable logic controller to verify that the medication container has arrived at the end of the at least one pneumatic pathway.

In another aspect of the present disclosure, which may be combined with any other aspect in combination with any other aspect listed herein unless specified otherwise, the data from the determinations of the first sensor and the third sensor are used by the programmable logic controller to determine a total latency of the medication container, and the total latency of the medication container is used in a trial-and-error loop to adjust a time at which the at least one butterfly valve should be closed.

In another aspect of the present disclosure, which may be combined with any other aspect in combination with any other aspect listed herein unless specified otherwise, the flow control braking system comprises four pneumatic pathways.

In another aspect of the present disclosure, which may be combined with any other aspect in combination with any other aspect listed herein unless specified otherwise, the flow control braking system comprises four butterfly valves, and each pneumatic pathway has one butterfly valve.

In another aspect of the present disclosure, which may be combined with any other aspect in combination with any other aspect listed herein unless specified otherwise, the programmable logic controller is configured to at least partially close each butterfly valve at a different time than each of the other butterfly valves.

In another aspect of the present disclosure, which may be combined with any other aspect in combination with any other aspect listed herein unless specified otherwise, the determined time is based at least in part on a type of the medication container in the pneumatic pathway.

In another aspect of the present disclosure, which may be combined with any other aspect in combination with any other aspect listed herein unless specified otherwise, the programmable logic controller is configured to pulse the at least one butterfly valve.

In another aspect of the present disclosure, which may be combined with any other aspect in combination with any other aspect listed herein unless specified otherwise, the programmable logic controller is configured to at least partially close the at least one butterfly valve at a determined time based at least in part on a user input.

In another aspect of the present disclosure, which may be combined with any other aspect in combination with any other aspect listed herein unless specified otherwise, a method of controlling a flow of a medication container in a pneumatic conveyance system is provided, where the method comprises providing a butterfly valve in a pneumatic pathway of the pneumatic conveyance system, providing a programmable logic controller in operative communication with the butterfly valve, providing a blower near a first end of the pneumatic pathway, causing the medication container to come into pneumatic communication with the blower in the pneumatic pathway, and causing, via the programmable logic controller, the butterfly valve to move to an at least partially closed position before the medication container reaches an end of the pneumatic pathway.

In another aspect of the present disclosure, which may be combined with any other aspect in combination with any other aspect listed herein unless specified otherwise, the method further comprises pulsing the butterfly valve via the programmable logic controller.

In another aspect of the present disclosure, which may be combined with any other aspect in combination with any other aspect listed herein unless specified otherwise, the butterfly valve is pulsed until the medication container reaches the end of the pneumatic pathway.

In another aspect of the present disclosure, which may be combined with any other aspect in combination with any other aspect listed herein unless specified otherwise, the spolling-reduction tube is configured to at least partially nest a spolling bottle in the at least one lobe to at least partially stop the spolling motion.

In another aspect of the present disclosure, which may be combined with any other aspect in combination with any other aspect listed herein unless specified otherwise, pulsing includes periodically switching the butterfly valve between a fully open position and a fully closed position.

In another aspect of the present disclosure, which may be combined with any other aspect in combination with any other aspect listed herein unless specified otherwise, pulsing includes periodically switching the butterfly valve between a fully open position and at least one partially open position.

In another aspect of the present disclosure, which may be combined with any other aspect in combination with any other aspect listed herein unless specified otherwise, pulsing includes periodically switching the butterfly valve between at least one partially open position and a fully closed position.

In another aspect of the present disclosure, which may be combined with any other aspect in combination with any other aspect listed herein unless specified otherwise, the programmable logic controller causes the butterfly valve to move to an at least partially closed position based at least in part on sensor data. The sensor data comprises a time of a first position of the medication container in the pneumatic pathway determined by a first sensor disposed on the pneumatic pathway and a time of a second position of the medication container in the pneumatic pathway determined by a second sensor disposed on the pneumatic pathway. Further, the programmable logic controller uses the sensor data to determine a velocity of the medication container in the pneumatic pathway.

In another aspect of the present disclosure, which may be combined with any other aspect in combination with any other aspect listed herein unless specified otherwise, the programmable logic controller causes the butterfly valve to move to an at least partially closed position based at least in part on a user input.

In another aspect of the present disclosure, which may be combined with any other aspect in combination with any other aspect listed herein unless specified otherwise, the method further comprises verifying that the medication container reaches the end of the pneumatic pathway.

In light of the present disclosure and the above aspects, it is therefore an advantage of the present disclosure to provide aa flow control braking system for transport of a medication container.

It is another advantage of the present disclosure to provide a system for controlling the velocity of a medication container in a pneumatic conveyance system pneumatic pathway.

It is another advantage of the present disclosure to provide a system that eliminates the need for compressed air on a medication container pneumatic conveyance system.

Additional features and advantages are described in, and will be apparent from, the following Detailed Description and the Figures. The features and advantages described herein are not all-inclusive and, in particular, many additional features and advantages will be apparent to one of ordinary skill in the art in view of the figures and description. In addition, any particular embodiment does not have to have all of the advantages listed herein and it is expressly contemplated to claim individual advantageous embodiments separately. Moreover, it should be noted that the language used in the specification has been selected principally for readability and instructional purposes, and not to limit the scope of the inventive subject matter.

### BRIEF DESCRIPTION OF THE FIGURES

FIG. 1 shows a side view of an example flow control braking system according to an embodiment of the present disclosure.

FIG. 2 shows an example flow control braking system in the context of a medication container sortation unit according to an embodiment of the present disclosure.

FIG. 3 shows a flowchart of an example method of flow control according to an embodiment of the present disclosure.

### DETAILED DESCRIPTION

Methods, systems, and apparatus are disclosed herein for controlling flow and medication container velocity in a pneumatic medication vial conveyance system. Specifically, systems, methods, and apparatus for proper conveyance of medication containers in a blower-fed pneumatic conveyance system are disclosed. The flow control and medication container velocity control enables an elimination of wasting vials and inefficiencies in the pneumatic conveyance systems during travel to a destination. The methods, systems, and apparatus are configured to utilize a blower and butterfly valves, eliminating dependence on compressed air systems.

Reference is made herein to medication containers. A medication container may refer to a medication vial, medication bottle, vial carrier, or other container for housing and moving medication. The medication held within the medication container may include pills, tablets, or other solid, gel, or liquid pharmaceutical drug dosage that is consumed by a patient. A medication may also include a compounded pharmaceutical that is prepared from two or more substances. The term medication is not intended to be limiting, and may be used interchangeably with terms such as medicament or drug.

A medication vial usually includes a cylindrical portion and a threaded region around an opening to accept a lid to ensure the medication stored within is secured and not able to be contaminated by exposure to outside elements. The medication vial also typically includes a label with medication information and/or patient information in its final state before patient disbursement. The label also includes a unique identifier for tracking the medication vial, such as a bar code. In some embodiments, the medication container may include a separate identifier to enable tracking of the medication container itself within a pharmacy automation system and/or a medication bagger system.

While the example methods, apparatus, and systems are disclosed herein as operating with medication vials, it should be appreciated that the methods, apparatus, and systems may be operable with other articles that have a bottle-type shape or otherwise able to be conveyed in a pneumatic conveyance system. For example, the methods, apparatus, and systems may provide for the routing of packages in a facility, products to be packaged in a facility, and/or components to be assembled into a product along an assembly line, such as for carbonated beverages or confections sold in bottles. The methods, apparatus, and systems are likewise applicable to a wide variety of products including, but not limited to, manufactured goods, perishable goods, food products, medical products, and other commercial products. It will be appreciated that the methods, apparatus, and systems may be used in other contexts as known by a person having ordinary skill in the art.

Furthermore, although the use of methods, systems, and apparatus for use in pneumatic conveyance systems is described, those of ordinary skill in the art will recognize that the use of such methods, systems, and apparatus are not limited to pneumatic conveyance systems, but could be used in other types of fluidic systems, such as hydraulic conveyance. Furthermore, the methods, systems, and apparatus are capable of employment in gravity-fed systems, since air may exist in these systems, and pressure profiles may be achievable by the use of a butterfly or other valve depending on the end conditions of the systems. Still further, although vials and bottles are described below, the methods, systems, and apparatus may be used on any geometry with the ability to be conveyed in the pneumatic conveyance systems used, and the below is meant to show an illustrative embodiment rather than a limiting geometrical use.

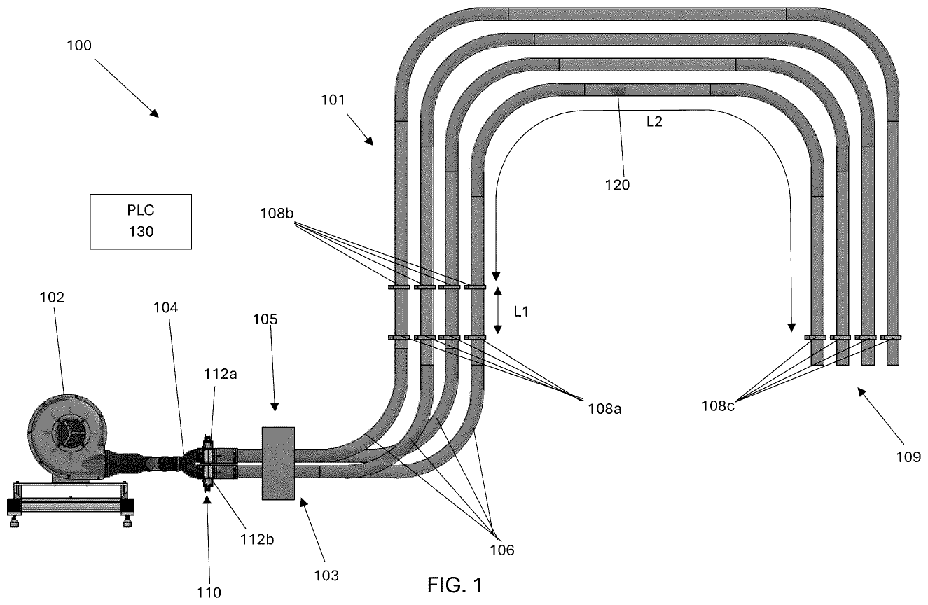

Turning now to FIG. 1, a flow control braking system 100 is illustrated. The flow control braking system 100 comprises a pneumatic conveyance system 101 configured for the transportation of medication containers 120 in the pneumatic conveyance system 101. Medication containers 120 are fed into a plurality of pneumatic pathways 106 by a bottle-feeding system 105 disposed toward a starting end 103 of the pneumatic pathways 106 are transported through the pneumatic pathways 106 towards destination end 109 of the pneumatic pathways 106. A blower 102 in pneumatic communication (which may more generally be referred to as fluid communication) with each of the pneumatic pathways 106 provides the air flow and fluid pressure for the transportation of the medication containers 120. A manifold 104 facilitates the fluid communication between the blower 102 and the pneumatic pathways 106. A flow control valve 112a, 112b controls the flow of air from the blower 102 to each of the pneumatic pathways 106 near an interface of the manifold 104 and the pneumatic pathway 106. Although only two flow control valves 112a, 112b are visible in FIG. 1, it should be understood that each pneumatic pathway 106 has its own dedicated flow control valve 112a, 112b in a preferred embodiment, but that for purposes of the description herein, only valves 112a and 112b will be referred to for illustrative purposes. Although the flow control braking system 100 is shown with a bottle-feeding system 105, it should be understood that any apparatus or method of feeding medication bottles 120 into the pneumatic pathways 106 may be employed, such as by manual operation.

Also in a preferred embodiment, the flow control valves 112a, 112b are butterfly valves, which allow for air to flow unimpeded from the blower 102 in an open configuration, no air to flow from the blower 102 to a corresponding pneumatic pathway 106 in a closed configuration, and for air to flow partially from the blower 102 in a partially-open configuration. Although the embodiments described will refer to butterfly valves, it should be understood that this term is not meant to limit the scope of the disclosure, and that alternative embodiments are contemplated which contain other types of valves such as ball valves, globe valves, diaphragm valves, gate valves, or any other valve capable of carrying out the flow control methods. The flow control valves 112a, 112b are controlled by a programmable logic controller 130 in operative communication with the pneumatic conveyance system 101. It will also be appreciated that the partially open configuration may include a plurality of positions of the flow control valve 112a, 112b which each allow a different amount of air flow to pass through the valve. The amount of positions in the partially open configuration is not intended to be limited.

The programmable logic controller is configured to switch the flow control valves 112a, 112b between the open configuration, closed configuration, and partially-open configuration (which may alternatively be referred to as a partially closed position). Non-transitory, computer implemented logic installed on the programmable logic controller 130 is used in deciding which configuration the flow control valves 112a, 112b will be in at a given time. The programmable logic controller 130 may be of any type capable of carrying out the functions of the disclosure and is not limited to any specific type or style. For example, a processor may be used as the programmable logic controller 130. The programmable logic controller 130 may include a memory which stores data sets of expected flow and velocity characteristics of different vials and with different degrees of openness from the flow control valves 112a, 112b. Such data may be input (for example by a user) or collected and/or calculated using real-time data of the system 100.

A series of sensors including first sensors 108a, second sensos 108b, and third sensors 108c are disposed at different points along each of the pneumatic pathways 106. The sensors 108a, 108b, 108c are configured to sense the presence (or absence) of a medication container 120 at the point in the pneumatic pathway 106 which the sensors 108a, 108b, 108c are disposed. The sensors 108a, 108b, 108c are in operative communication with the programmable logic controller 130 such as to be able to send data indicating the presence of a medication container 120 in the pneumatic pathway 106 at a certain time. In a preferred embodiment, the second sensors 108b are disposed downstream of the first sensors 108a on the pneumatic pathway 106 at a known first distance L1 from each other. By calculating the time it takes for a medication container 120 to reach the second sensor 108b from the first sensor 108a over the first distance L1, a velocity of the medication container 120 can be established in the programmable logic controller 130. Because the system uses constant forced air from the blower 102 in a closed pneumatic pathway 106, velocity losses will be negligible compared to compressed air systems, such that in a preferred embodiment the velocity of the medication container 120 at the second sensor 108b is considered to be the velocity of the medication container 120 in the duration of the pneumatic pathway until a change in configuration of the flow control valve 112a, 112b.

Once the velocity of the medication container 120 is established, the programmable logic controller 130 determines when a partially-closed configuration or a closed configuration of the flow control valve 112a, 112b should occur in order to have the medication container 120 arrive at the destination end 109 with minimal velocity. Medication containers typically comprise rigid plastics or ceramics (e.g. glass) which may shatter or break if they reach the destination end 109 at too high of a velocity. Switching the flow control valve 112a, 112b reduces the velocity of the medication container 120 at a desired point in the pneumatic pathway known by calculating the position from the velocity over the amount of time since the medication container was present at the second sensor 108b along a second length L2 between the second sensor 108b and the third sensor 108c, the third sensor 108c disposed at or near the destination end 109. Implementing fluid dynamics principles or experimentally measured data for specific bottle types, a desired time for a closed configuration or a partially-open configuration of the flow control valve 112a, 112b can be determined by the programmable logic controller 130 for the medication container 120 to reach the destination end 109 with minimal velocity. In such a configuration, the third sensors 108c may be used to confirm or verify that the medication container 120 arrived at the destination end 109 so that the process may be repeated.

If the third sensor 108c does not sense a presence of the medication container 120 at a specified expected time, then the flow control valve 112a, 112b may be pulsed in order to get a stopped or stuck medication container 120 to reach the destination end 109 without exceeding a desired maximum velocity. Pulsing may comprise periodically switching the flow control valve 112a, 112b between any of the configurations. For instance, pulsing may control repeatedly switching the configuration of the flow control valve 112a, 112b between the closed configuration and the open configuration, between the closed configuration and the partially open configuration, between the open configuration and the partially open configuration, or between any combination of those combinations (for instance, a period of (i) open configuration; (ii) partially open configuration; (iii) closed configuration; (iv) partially open configuration; (v) closed configuration; (vi) partially open configuration; (vii) open configuration). In a preferred embodiment, pulsing is performed until the third sensor 108c senses the presence of a medication container 120 or a user override is given to the programmable logic controller 130.

In an alternative embodiment, the flow control valves 112a, 112b can be implemented to maintain a constant velocity low enough to minimize damage to the medication containers 120 when arriving at the destination end 109. For instance, a partially-open configuration may be implemented on the flow control valves 112a, 112b in order to maintain a velocity of the medication container 120 below a maximum available velocity from the open configuration. In such a configuration, the velocity determined by data from the first sensor 108a and the second sensor 108b over the first length L1 is used to verify that the actual velocity is equal to or near a desired velocity of the medication container 120 for the second length L2.

In yet another alternative embodiment, the first sensor 108a is used to determine when a medication container reaches a certain point in the pneumatic pathway 106 and a time delay is used by the programmable logic controller 130 to determine when a closed configuration or partially open configuration of the flow control valve 112a, 112b should occur. The third sensor 108c is still used to verify that the medication container 120 has reached the destination end 109, but in this embodiment the second sensor 108b is not necessary and therefore optional, although it may still be useful in refining the data set in the programmable logic controller 130 by a feedback loop, as described below.

In another alternative embodiment, a user input is given to the programmable logic controller 130 for an amount of travel time desired for the medication container 120 through the pneumatic pathway 106 or for a final velocity at the destination end 109, and the programmable logic controller 130 causes the flow control valve 112a, 112b to have a certain configuration based on the user input. The third sensor 108c is still used to verify that the medication container 120 has reached the destination end 109, but in this embodiment the first sensor 108a and second sensor 108b are not necessary and therefore optional, although they may still be useful in refining the data set in the programmable logic controller 130 by a feedback loop, as described below.

In any arrangement or embodiment, the data from the sensors 108a, 108b, 108c may be used in a feedback loop to refine the flow and velocity control characteristics stored in the programmable logic controller 130. For example, a dataset in the programmable logic controller 130 may contain the expected velocity of a plurality of types of medication containers 120 at a plurality of flow control valve 112a, 112b positions in the partially open configuration. Data from the first sensors 108a and second sensors 108b may be used to calculate an actual velocity of the medication container 120. Any deviation between the actual velocity and the expected velocity, which in some instances may be referred to as a latency of the medication vial, can be used either to adjust the current flow control valve 112a, 112b configuration for the current medication container 120 or to adjust the data set permanently for later medication containers 120, or both.

Data may also be received in the feedback loop which increases the precision of the flow control braking system 100 when certain conditions are present. For instance, when a first flow control valve 112a is in a closed position, the other pneumatic pathways 106 may experience an increased flow of air from the pressure created by the closed valve. Through data collection and implementation of the feedback loop, the flow control braking system 100 is capable of predicting the flow conditions in a pneumatic pathway 106 when the other pneumatic pathways 106 have flow control valves 112a, 112b in a plurality of configurations.

In any arrangement or embodiment, a user input may be capable of overriding any setting from the programmable logic controller 130 as necessary to carry out the intended purpose of the flow control braking system 100.

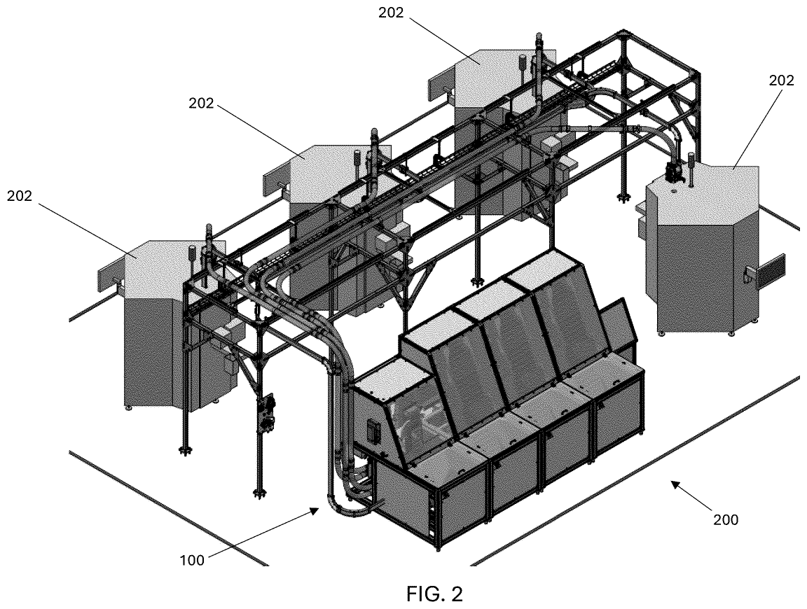

Although the system 100 is depicted with four pneumatic pathways 106 in the preferred embodiment of FIG. 1, alternative embodiments are contemplated with as few as one pneumatic pathway 106, or as many pneumatic pathways 106 as can be reasonably achieved with a given blower 102. The system 100 may be part of a medication container sortation unit 200 where each pneumatic pathway 106 terminates at a modular medication container filling unit 202, as depicted in FIG. 2. The number of pneumatic pathways 106 is driven by the number of medication container filling units 202 in the medication container sortation unit 200.

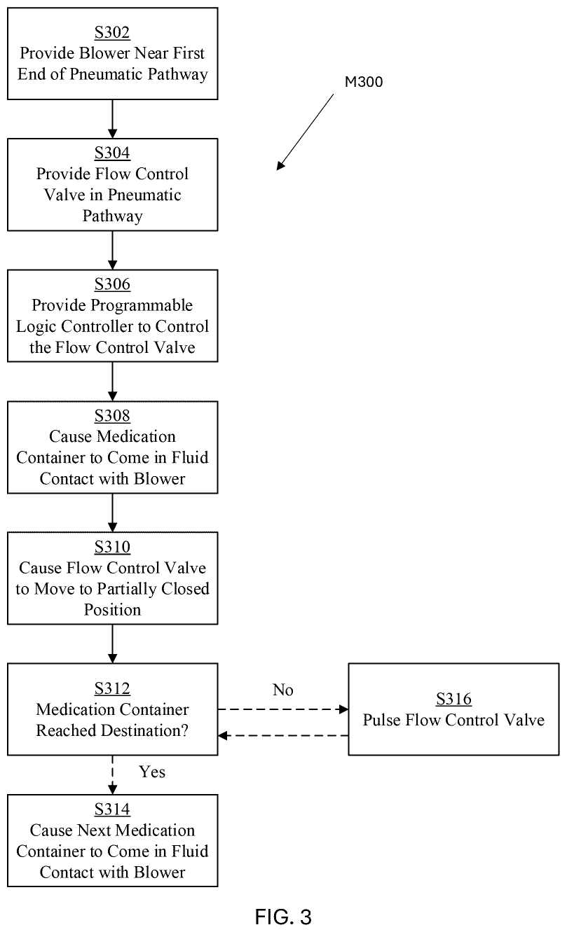

FIG. 3 shows a flowchart of a process M300 for controlling a flow of a medication container in a pneumatic conveyance system. The process begins with step S302 where a blower 102 is provided at or near a first end of at least one pneumatic pathway 106. At step S304 a flow control valve 112a, 112b is provided in the pneumatic pathway which controls the flow of air from the blower 102. At step S306 a programmable logic controller 130 is provided which controls the flow control valve 112a, 112b. At step S308 a medication container 120 comes into the pneumatic pathway 106 which puts the medication container 120 in fluid contact with the air coming from the blower 102, which in turn causes the medication container 120 to move through the pneumatic pathway 106 towards the destination end 109. At step S310 the programmable logic controller 130 causes the flow control valve 112a, 112b to move to an at least partially closed position (partially open configuration or closed configuration). At step S312 a verification occurs to determine if the medication container 120 reached the destination end 109 as intended. If it cannot be verified that the medication container 120 made it to the destination, then the flow control valve 112a, 112b is pulsed and step S312 is repeated as necessary until it is verified that the medication container 120 reached the destination end 109, at which point the process moves to step S314 where the next medication container 120 is put into fluid contact with the blower 102 by the feeder 105. A user input may be able to override determination at step S312 in order to make the process proceed to step S314 without receiving verification of the medication container 120 reaching the destination end 109.

The methods described above may be performed in any order and the methods described above may include more, fewer, or other steps. Further, the methods described may be modified as understood according to the various embodiments of the described system in order to carry out the functions of the same.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A flow control braking system comprising:
a programmable logic controller;
a blower;
at least one pneumatic pathway in pneumatic communication with the blower;
at least one butterfly valve in pneumatic communication with the blower and the at least one pneumatic pathway; and
a plurality of sensors disposed along the pneumatic pathway,
wherein the plurality of sensors and the at least one butterfly valve are in operative communication with the programmable logic controller,
wherein a first sensor of the plurality of sensors is configured to determine when a medication container is present at a first position in the at least one pneumatic pathway,
wherein a second sensor of the plurality of sensors is disposed downstream of the first sensor and is configured to determine when the medication container is present at a second position in the at least one pneumatic pathway, and
wherein the programmable logic controller is configured to at least partially close the at least one butterfly valve at a determined time based at least in part on data from the determinations of the first sensor and the second sensor.

2. The system of claim 1, wherein the data from the determinations from the first sensor and the second sensor are used by the programmable logic controller to determine a speed of the medication container.

3. The system of claim 2, further comprising a third sensor,
wherein the third sensor is disposed downstream of the second sensor, and
wherein the third sensor is configured to determine when the medication container is present at a third position in the at least one pneumatic pathway.

4. The system of claim 3, wherein the third position is disposed near an end of the at least one pneumatic pathway and data from the determination of the third sensor is used by the programmable logic controller to verify that the medication container has arrived at the end of the at least one pneumatic pathway.

5. The system of claim 3, wherein the data from the determinations of the first sensor and the third sensor are used by the programmable logic controller to determine a total latency of the medication container, and wherein the total latency of the medication container is used in a trial-and-error loop to adjust a time at which the at least one butterfly valve should be closed.

6. The system of claim 1, wherein the flow control braking system comprises four pneumatic pathways.

7. The system of claim 6, wherein the flow control braking system comprises four butterfly valves, wherein each pneumatic pathway has one butterfly valve.

8. The system of claim 7, wherein the programmable logic controller is configured to at least partially close each butterfly valve at a different time than each of the other butterfly valves.

9. The system of claim 7, wherein the determined time is based at least in part on a type of the medication container in the pneumatic pathway.

10. The system of claim 1, wherein the programmable logic controller is configured to pulse the at least one butterfly valve.

11. The system of claim 1, wherein the programmable logic controller is configured to at least partially close the at least one butterfly valve at a determined time based at least in part on a user input.

12. A method of controlling a flow of a medication container in a pneumatic conveyance system, the method comprising:
providing a butterfly valve in a pneumatic pathway of the pneumatic conveyance system;
providing a programmable logic controller in operative communication with the butterfly valve;
providing a blower near a first end of the pneumatic pathway;
causing the medication container to come into pneumatic communication with the blower in the pneumatic pathway; and
causing, via the programmable logic controller, the butterfly valve to move to an at least partially closed position before the medication container reaches an end of the pneumatic pathway.

13. The method of claim 12, further comprising pulsing the butterfly valve via the programmable logic controller.

14. The method of claim 13, wherein the butterfly valve is pulsed until the medication container reaches the end of the pneumatic pathway.

15. The method of claim 13, wherein pulsing includes periodically switching the butterfly valve between a fully open position and a fully closed position.

16. The method of claim 13, wherein pulsing includes periodically switching the butterfly valve between a fully open position and at least one partially open position.

17. The method of claim 13, wherein pulsing includes periodically switching the butterfly valve between at least one partially open position and a fully closed position.

18. The method of claim 12, wherein the programmable logic controller causes the butterfly valve to move to an at least partially closed position based at least in part on sensor data comprising:
a time of a first position of the medication container in the pneumatic pathway determined by a first sensor disposed on the pneumatic pathway; and
a time of a second position of the medication container in the pneumatic pathway determined by a second sensor disposed on the pneumatic pathway,
wherein the programmable logic controller uses the sensor data to determine a velocity of the medication container in the pneumatic pathway.

19. The method of claim 12, wherein the programmable logic controller causes the butterfly valve to move to an at least partially closed position based at least in part on a user input.

20. The method of claim 12, further comprising:
verifying that the medication container reaches the end of the pneumatic pathway.
